(19) United States
(12) Patent Application Publication
(10) Pub. No.: US 2022/0134487 A1
(43) Pub. Date: May 5, 2022

(54) JOINED BODY AND METHOD OF MANUFACTURING JOINED BODY

(71) Applicant: NGK INSULATORS, LTD., Nagoya-City (JP)

(72) Inventors: Shinji SUZUKI, Nagoya-City (JP); Takafumi KIMATA, Nagoya-City (JP); Takahiro TOMITA, Chita-City (JP)

(73) Assignee: NGK INSULATORS, LTD., Nagoya-City (JP)

(21) Appl. No.: 17/451,211

(22) Filed: Oct. 18, 2021

(30) Foreign Application Priority Data
Oct. 29, 2020 (JP) 2020-181757

(51) Int. Cl. B23K 35/02; B23K 35/36

(52) U.S. Cl. CPC B23K 35/0261; B23K 2101/06; B23K 35/361; B23K 35/3602

(57) ABSTRACT

A joined body includes a junction target, an underlying layer, an electrode part, and a fixed layer. The conductive underlying layer is fixed on a surface of the junction target. The electrode part is fixed on the underlying layer. The conductive fixed layer is fixed on the underlying layer with the electrode part interposed therebetween. Respective porosities of the underlying layer and the fixed layer are each not higher than 10%.

### CROSS REFERENCE TO RELATED APPLICATION

The present application claims the benefit of priority to Japanese Patent Application No. 2020-181757 filed on Oct. 29, 2020, the content of which is incorporated herein by reference in its entirety.

### TECHNICAL FIELD

The present invention relates to a joined body and a method of manufacturing the joined body.

### BACKGROUND ART

Conventionally, in order to perform a purification treatment of toxic substances such as HC, CO, NOx, or the like contained in exhaust gas discharged from an engine of an automobile or the like, a catalytic converter having a columnar honeycomb structure or the like which supports a catalyst has been used. In such a catalytic converter, the temperature of the catalyst needs to rise to an activation temperature in an exhaust gas purification treatment, but since the temperature of the catalytic converter is low immediately after startup of the engine, or so on, there is a possibility that the exhaust gas purification performance may be reduced. Especially, in a plug-in hybrid electrical vehicle (PHEV) or a hybrid vehicle (HV), since the vehicle runs on motor only, the temperature of the catalyst easily decreases.

Then, used is an electrically heated catalyst (EHC) in which a conductive catalytic converter is connected to a pair of electrodes and causes itself to generate heat by energization, to thereby preheat the catalyst.

In Patent Publication No. 5246337 (Document 1), for example, proposed is an electrically heated catalyst in which an electrode part is fixed on a SiC carrier. In the electrically heated catalyst, an underlying layer which is a porous membrane is formed on a surface of the SiC carrier by spraying, a comb electrode is disposed on the underlying layer, and further a fixed layer is formed on surfaces of the comb electrode and the underlying layer by spraying.

Further, in Japanese Patent Application Laid-Open No. 2017-171526 (Document 2), proposed is a technique in which in joining a metal member to a SiC-based ceramic body of the electrically heated catalyst, a first junction layer is formed on a surface of the ceramic body and the metal member disposed on the first junction layer is covered with a second junction layer from above and fired. The first junction layer contains an alloy whose main components are Fe and Cr, and in the alloy, a low thermal expansion compound such as crystalline cordierite or the like is dispersed. The second junction layer contains an alloy whose main components are Fe and Cr and has a thermal expansion coefficient higher than that of the first junction layer.

### SUMMARY OF INVENTION

In the electrically heated catalyst, required is the joint reliability (i.e., the mechanical joint reliability and the electrical joint reliability) of the electrode in a high temperature oxidation atmosphere inside an exhaust pipe of an automobile or the like. In the electrically heated catalyst disclosed in Document 1, however, the underlying layer and the fixed layer used to join the SiC carrier and the comb electrode are porous since these layers are formed by spraying. For this reason, in the above-described high temperature oxidation atmosphere, the underlying layer and the fixed layer are easily oxidized, and in the junction between the SiC carrier and the comb electrode, there is a possibility that the mechanical strength may be reduced and the energization performance may be also reduced. In other words, in the junction between the SiC carrier and the comb electrode, which is formed by spraying, there is a possibility that the oxidation resistance at a junction part may be reduced and the joint reliability may be reduced. Further, also in the joining method disclosed in Document 2, since the junction layer becomes porous due to an influence of crystalline cordierite, or the like, there is a limitation in the increase of the oxidation resistance in the junction between the ceramic body and the metal member.

The present invention is intended for a joined body, and it is an object of the present invention to achieve high oxidation resistance in junction between a junction target and an electrode part.

The joined body according to one preferred embodiment of the present invention includes a junction target, a conductive underlying layer fixed on a surface of the junction target, an electrode part fixed on the conductive underlying layer, and a conductive fixed layer fixed on the conductive underlying layer with the electrode part interposed therebetween. Respective porosities of the conductive underlying layer and the conductive fixed layer are each not higher than 10%.

According to the joined body, it is possible to achieve high oxidation resistance in junction between the junction target and the electrode part.

Preferably, the junction target is a conductive carrier for supporting a catalyst in an electrically heated catalyst. The electrode part is part of an electrode terminal for supplying electric power to the conductive carrier.

Preferably, the junction target includes a conductive base material having a honeycomb structure and a conductive electrode layer disposed between the conductive underlying layer and an outer surface of the conductive base material.

Preferably, each of the conductive underlying layer and the conductive fixed layer contains a metal and an oxide.

Preferably, the softening temperature of the oxide is lower than the heating temperature in formation of the conductive underlying layer and the conductive fixed layer.

Preferably, the component of the conductive underlying layer is the same as that of the conductive fixed layer.

Preferably, the thickness of the conductive fixed layer is not smaller than 100 μm.

Preferably, the area of a portion of the electrode part, which overlaps the conductive fixed layer in a plan view, is not smaller than 5% and not larger than 80% of the area of the conductive fixed layer in a plan view.

Preferably, the thickness of a portion of the electrode part, which is positioned between the conductive underlying layer and the conductive fixed layer, is not smaller than 10 μm and not larger than 1000 μm.

Preferably, the electrode part contains aluminum.

Preferably, respective thermal expansion coefficients of the conductive underlying layer and the conductive fixed layer are each higher than that of a portion of the junction target, on which the conductive underlying layer is fixed, and lower than that of the electrode part.

Preferably, the conductive underlying layer and the conductive fixed layer are formed by sintering a raw material disposed on the junction target, together with the junction target.

Preferably, the electrode part includes a first portion extended out from between the conductive underlying layer and the conductive fixed layer and a second portion joined to the first portion by welding at a position away from the conductive underlying layer and the conductive fixed layer.

The present invention is also intended for a method of manufacturing a joined body. The joined body which includes a junction target, a conductive underlying layer fixed on a surface of the junction target, an electrode part fixed on the conductive underlying layer, and a conductive fixed layer fixed on the conductive underlying layer with the electrode part interposed therebetween. The method of manufacturing the joined body includes a) applying underlying layer paste which is a raw material of the conductive underlying layer, onto a surface of the junction target, b) disposing the electrode part on the underlying layer paste, c) forming a joined body precursor by applying fixed layer paste which is a raw material of the conductive fixed layer, onto the underlying layer paste or the conductive underlying layer which is formed by sintering the underlying layer paste, with the electrode part interposed therebetween, and d) sintering the joined body precursor. The sintering temperature is not lower than 900° C. and not higher than 1400° C. and the sintering atmosphere is an inert gas atmosphere in the operation d). Respective porosities of the conductive underlying layer and the conductive fixed layer after the operation d) are each not higher than 10%.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a cross section showing a joined body in accordance with one preferred embodiment;

FIG. 2 is a plan view showing the vicinity of an electrode part;

FIG. 3 is an enlarged plan view showing the vicinity of the electrode part;

FIG. 4 is an enlarged cross section showing the vicinity of the electrode part;

FIG. 5 is a flowchart showing an operation flow for manufacturing the joined body;

FIG. 6 is a plan view showing a specimen;

FIGS. 7A and 7B are enlarged plan views each showing the vicinity of the electrode part;

FIG. 8 is a SEM image of a cross section of the electrode part and a junction part; and

FIG. 9 is a plan view showing the vicinity of the electrode part.

### DESCRIPTION OF EMBODIMENTS

FIG. 1 is a cross section showing a joined body 1 in accordance with one preferred embodiment of the present invention. The joined body 1 is a columnar member which is long in one direction, and FIG. 1 shows a cross section perpendicular to a longitudinal direction of the joined body 1. The joined body 1 is used as an electrically heated catalyst (EHC) for performing a purification treatment of exhaust gas discharged from an engine of an automobile or the like or a heater for heating an object to be heated. Hereinafter, description will be made, assuming that the joined body 1 is the electrically heated catalyst.

The joined body 1 includes a structure 2, an electrode part 3, and a junction part 4. The structure 2, the electrode part 3, and the junction part 4 are each conductive. The structure 2 is a carrier supporting a catalyst in the electrically heated catalyst. The electrode part 3 is fixed on a surface of the substantially columnar structure 2 by using the junction part 4. In other words, the structure 2 is a junction target to which the electrode part 3 is to be joined.

The structure 2 includes a substantially columnar base material 20 having a honeycomb structure and a pair of electrode layers 25 which are fixed on an outer surface of the base material 20. The base material 20 and the electrode layers 25 are each conductive. The base material 20 is a cell structure which are sectioned into a plurality of cells 23 inside. The pair of electrode layers 25 are foil-like or plate-like members which are arranged, facing each other with a central axis J1 sandwiched therebetween. The central axis J1 extends in a longitudinal direction of the base material 20. Each of the electrode layers 25 is provided along the outer surface of the base material 20. The substantially strip-like electrode part 3 is joined on a surface of each electrode layer 25.

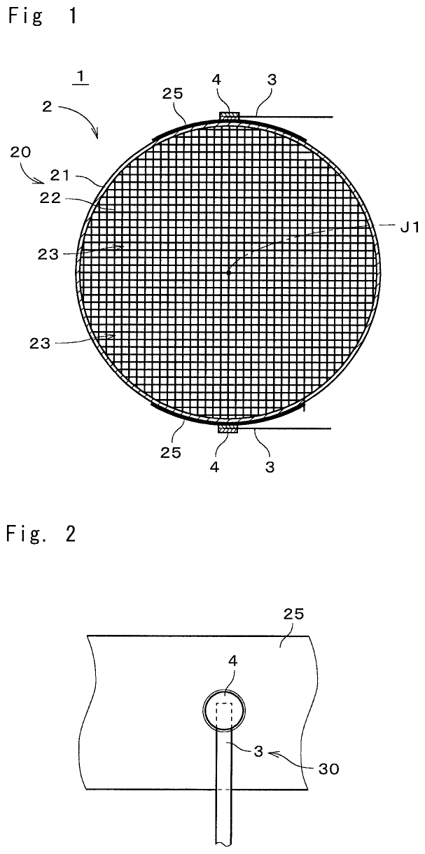

FIG. 2 is a plan view showing the vicinity of the electrode part 3 on one of the pair of electrode layers 25. The left and right direction in FIG. 2 corresponds to the longitudinal direction of the joined body 1. A direction perpendicular to this paper of FIG. 2 corresponds to a radial direction around the central axis J1 (hereinafter, also referred to simply as a “radial direction”). In the exemplary case shown in FIG. 2, one electrode part 3 is joined to the electrode layer 25 by using the junction part 4. The electrode part 3 is part of an electrode terminal 30 which supplies electric power to the structure 2. The number of and the arrangement of electrode parts 3 on the other electrode layer 25 are the same as those in FIG. 2. Further, the number of and the arrangement of electrode parts 3 may be changed as appropriate.

The electrode part 3 is connected to a not-shown power supply. When the power supply applies a voltage across the pair of electrode layers 25 through the electrode part 3, a current flows in the structure 2 and the structure 2 generates heat by the Joule heat. The voltage applied to the joined body 1 is, for example, 12 V to 900 V, and preferably 64 V to 600 V. The electrical resistivity of ceramics forming the base material 20 is, for example, 1 Ω·cm to 200 Ω·cm, and preferably 10 Ω·cm to 100 Ω·cm. The electrical resistivity is a value measured by the four-probe (four-terminal) method at 400° C., and the same applies to the following description. Further, the electrical resistivity and the above-described voltage may be changed as appropriate.

As shown in FIG. 1, the base material 20 includes a cylindrical outer wall 21 and a barrier rib 22. The cylindrical outer wall 21 is a cylindrical portion extending in the longitudinal direction (direction perpendicular to this paper of FIG. 1). A cross-sectional shape of the cylindrical outer wall 21 which is perpendicular to the longitudinal direction is substantially circular. The cross-sectional shape may be any other shape such as an elliptical shape, a polygonal shape, or the like.

The barrier rib 22 is provided inside the cylindrical outer wall 21 and is a lattice member sectioning the inside thereof into a plurality of cells 23. Each of the plurality of cells 23 is a space extending over substantially the full length of the base material 20 in the longitudinal direction. Each cell 23 is a flow passage in which the exhaust gas flows, and the catalyst used for the purification treatment of the exhaust gas is supported by the barrier rib 22. A cross-sectional shape of the cell 23 which is perpendicular to the longitudinal direction is, for example, a substantial rectangle. The cross-sectional shape may be any other shape such as a polygonal shape, a circular shape, or the like. In terms of reduction in the pressure loss in the flow of the exhaust gas in the cell 23, it is preferable that the cross-sectional shape should be a quadrangle or a hexagon. Further, in terms of increase in the structural strength and the uniformity of heating in the base material 20, it is preferable that the cross-sectional shape should be a rectangle. The plurality of cells 23 have the same cross-sectional shape in principle. The plurality of cells 23 may include some cells 23 each having a different cross-sectional shape.

The length of the cylindrical outer wall 21 in the longitudinal direction is, for example, 30 mm to 200 mm. The outer diameter of the cylindrical outer wall 21 is, for example, 25 mm to 80 mm. In terms of increase in the heat resistance of the base material 20, the area of a bottom surface of the base material 20 (i.e., the area of a region surrounded by the cylindrical outer wall 21 in the bottom surface of the base material 20) is preferably 2000 mm² to 20000 mm², and further preferably 5000 mm² to 15000 mm². In terms of prevention of outflow of a fluid flowing in the cell 23, increase in the strength of the base material 20, and the strength balance between the cylindrical outer wall 21 and the barrier rib 22, the thickness of the cylindrical outer wall 21 is, for example, 0.1 mm to 1.0 mm, preferably 0.15 mm to 0.7 mm, and more preferably 0.2 mm to 0.5 mm.

The length of the barrier rib 22 in the longitudinal direction is substantially the same as that of the cylindrical outer wall 21. In terms of increase in the strength of the base material 20 and reduction in the pressure loss in the flow of the exhaust gas in the cell 23, the thickness of the barrier rib 22 is, for example, 0.1 mm to 0.3 mm and preferably 0.15 mm to 0.25 mm.

The barrier rib 22 may be porous. In this case, in terms of suppression of deformation in sintering and increase in the strength of the base material 20, the porosity of the barrier rib 22 is, for example, 35% to 60%, and preferably 35% to 45%. The porosity can be measured, for example, by a mercury porosimeter. In terms of suppressing the electrical resistivity from becoming excessively high or excessively low, the average pore diameter of the barrier rib 22 is, for example, 2 μm to 15 μm, and preferably 4 μm to 8 μm. The average pore diameter can be measured, for example, by the mercury porosimeter.

In terms of increase in the area of the barrier rib 22 which supports the catalyst and reduction in the pressure loss in the flow of the exhaust gas in the cell 23, the cell density of the base material 20 (i.e., the number of cells 23 per unit area in the cross section perpendicular to the longitudinal direction) is, for example, 40 cell/cm² to 150 cell/cm², and preferably 70 cell/cm² to 100 cell/cm². The cell density can be obtained by dividing the number of all cells in the base material 20 by the area of a region inside an inner peripheral edge of the cylindrical outer wall 21 in the bottom surface of the base material 20. The size of the cell 23, the number of cells 23, the cell density, and the like may be changed in various manners.

The base material 20 is formed of, for example, conductive ceramics, a metal, or a composite material of the conductive ceramics and the metal. The component of the base material 20 may be, for example, oxide ceramics such as alumina, mullite, zirconia, cordierite, or the like, or may be non-oxide ceramics such as silicon carbide, silicon nitride, aluminum nitride, or the like. Further, the component of the base material 20 may be a silicon-silicon carbide composite material, a silicon carbide-graphite composite material, or the like. In terms of compatibility between the heat resistance and the conductivity, the component of the base material 20 is preferably ceramics whose main component is silicon carbide (SiC) or a silicon-silicon carbide (Si—SiC) composite material (specifically, containing 90 mass percentage or more), and more preferably SiC or a Si—SiC composite material. The Si—SiC composite material contains SiC particles as an aggregate and Si as a binder for binding the SiC particles, and it is preferable that a plurality of SiC particles should be so bound by Si as to form a pore between the SiC particles.

The electrode layer 25 extends in the longitudinal direction along the outer surface of the base material 20 and spreads in a circumferential direction around the central axis J1 (hereinafter, also referred to simply as a “circumferential direction”). The electrode layer 25 spreads the current from the electrode part 3 in the longitudinal direction and the circumferential direction, to thereby increase the uniformity of heat generation of the base material 20. The length of the electrode layer 25 in the longitudinal direction is, for example, 80% or more of the length of the base material 20 in the longitudinal direction, and preferably 90% or more. More preferably, the electrode layer 25 extends over the full length of the base material 20. The angle of the electrode layer 25 in the circumferential direction (i.e., an angle formed by two line segments extending from both ends of the electrode layer 25 in the circumferential direction to the central axis J1) is, for example, 30° or more, preferably 40° or more, and more preferably 60° or more. On the other hand, in terms of suppressing the current flowing inside the base material 20 from decreasing due to the pair of electrode layers 25 which are too close, the angle of the electrode layer 25 in the circumferential direction is, for example, 140° or less, preferably 130° or less, and more preferably 120° or less.

In the exemplary case shown in FIG. 1, though the angle between centers of the pair of electrode layers 25 in the circumferential direction (i.e., the angle formed by two line segments extending from the respective centers of the two electrode layers 25 in the circumferential direction to the central axis J1 in FIG. 1) is 180°, this angle (180° or less) may be changed as appropriate. The angle is, for example, 150° or more. preferably 160° or more, and more preferably 170° or more.

In terms of preventing the electric resistance from becoming excessively high and preventing any breakage in canning, the thickness of the electrode layer 25 (i.e., the thickness in the radial direction) is, for example, 0.01 mm to 5 mm, and preferably 0.01 mm to 3 mm.

It is preferable that the electrical resistivity of the electrode layer 25 should be lower than that of the base material 20. The current thereby flows more easily to the electrode layer 25 than the base material 20 and the current is more easily spread in the longitudinal direction and the circumferential direction of the structure 2. The electrical resistivity of the electrode layer 25 is, for example, 1/10 of that of the base material 20 or less, preferably 1/20 thereof or less, and more preferably 1/30 thereof or less. On the other hand, in terms of suppressing the current from being concentrated between end portions of the pair of electrode layers 25, the electrical resistivity of the electrode layer 25 is, for example, 1/200 of that of the base material 20 or more, preferably 1/150 thereof or more, and more preferably 1/100 thereof or more.

The electrode layer 25 is formed of, for example, conductive ceramics, a metal, or a composite material of the conductive ceramics and the metal. The conductive ceramics is, for example, SiC or a metal silicide such as tantalum silicide (TaSi₂), chromium silicide (CrSi₂), or the like. The metal is, for example, chromium (Cr), iron (Fe), cobalt (Co), nickel (N), Si, or titanium (Ti). In terms of reduction in the thermal expansion coefficient, the component of the electrode layer 25 may be a composite material in which alumina, mullite, zirconia, cordierite, silicon nitride, aluminum nitride, or the like is added to one kind of or two or more kinds of metals. The thermal expansion coefficient (linear expansion coefficient) of the electrode layer 25 is, for example, 3×10⁻⁶/K to 10×10⁻⁶/K, and preferably 4×10⁻⁶/K to 8×10⁻⁶/K.

It is preferable that the component of the electrode layer 25 should be a material which can be sintered together with the base material 20. In terms of compatibility between the heat resistance and the conductivity, the component of the electrode layer 25 is preferably ceramics whose main component is silicon carbide (SiC) or a silicon-silicon carbide (Si—SiC) composite material (specifically, containing 90 mass percentage or more), and more preferably SiC or a Si—SiC composite material. The Si—SiC composite material contains SiC particles as an aggregate and Si as a binder for binding the SiC particles, and it is preferable that a plurality of SiC particles should be so bound by Si as to form a pore between the SiC particles.

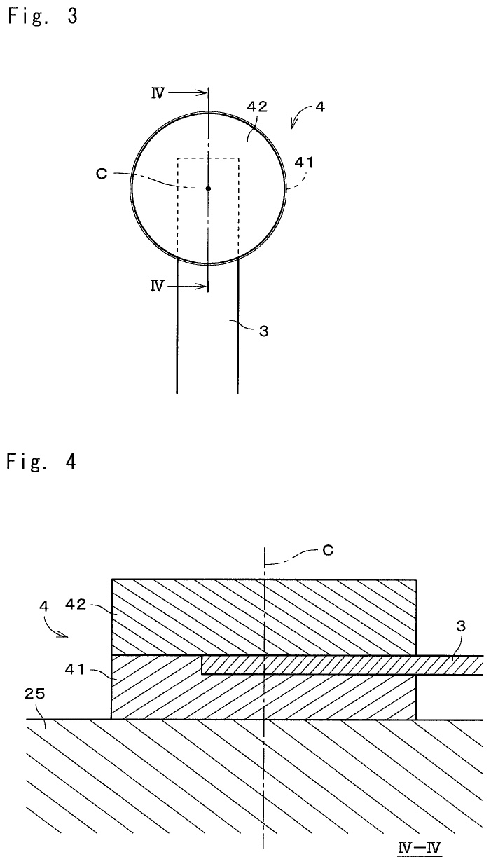

FIG. 3 is a view enlargedly showing the vicinity of the electrode part 3 and the junction part 4. In the following description, as shown in FIG. 3, a state viewed from the radial direction is referred to as a “plan view”. FIG. 4 is a cross section showing the electrode part 3, the junction part 4, and the like taken at the position of IV-IV of FIG. 3. In FIG. 4, respective thicknesses of the electrode part 3 and the junction part 4 are shown larger than the actual thicknesses. The junction part 4 includes an underlying layer 41 and a fixed layer 42. The underlying layer 41 and the fixed layer 42 are each conductive.

The underlying layer 41 is directly fixed on a surface of the electrode layer 25 of the structure 2. In other words, the underlying layer 41 is indirectly fixed on the outer surface of the base material 20 (see FIG. 1) with the electrode layer 25 interposed therebetween. Further in other words, the electrode layer 25 is disposed between the underlying layer 41 and the outer surface of the base material 20. The electrode part 3 is directly fixed on the underlying layer 41. In other words, the electrode part 3 is directly fixed on a surface of the underlying layer 41, which is on the opposite side of the structure 2. The fixed layer 42 is directly fixed on the underlying layer 41 with the electrode part 3 interposed therebetween.

In the exemplary case shown in FIG. 3, the respective shapes of the underlying layer 41 and the fixed layer 42 in a plan view (i.e., the shapes viewed from the radial direction) are substantially circular, having substantially the same size. The underlying layer 41 and the fixed layer 42 overlap each other substantially on the whole in a plan view. The shape of the electrode part 3 in a plan view is a substantially rectangular strip-like shape. The respective diameters of the underlying layer 41 and the fixed layer 42 are each, for example, 1 mm to 10 mm. The width of the electrode part 3 in a plan view (i.e., the width in the left and right direction of FIG. 3) is smaller than the diameters of the underlying layer 41 and the fixed layer 42 and, for example, 0.5 mm to 3.0 mm. In the exemplary case shown in FIG. 3, the width of the electrode part 3 in a plan view is substantially constant in a range where the electrode part 3 overlaps the underlying layer 41 and the fixed layer 42.

The electrode part 3 protrudes downward from a lower end portion of the junction part 4 in FIG. 3. Preferably, the electrode part 3 overlaps the center C of the fixed layer 42 in the radial direction in a plan view (i.e., the direction perpendicular to this paper of FIG. 3). More preferably, a tip (i.e., an upper end in FIG. 3) of the electrode part 3 is positioned on a side of the electrode part 3 opposite to the protruding portion from the junction part 4 with the center C of the fixed layer 42 interposed therebetween. The electrode part 3 may penetrate the fixed layer 42 in an up-and-down direction of FIG. 3. The area of a portion of the electrode part 3 which overlaps the fixed layer 42 in a plan view is preferably not smaller than 5% of the area of the fixed layer 42 in a plan view and not larger than 80% thereof, and more preferably not smaller than 25% thereof and not larger than 50% thereof. At a position where the electrode part 3 is present in a plan view, the underlying layer 41, the electrode part 3, and the fixed layer 42 are laminated on the structure 2 in this order. Further, at a position where the electrode part 3 is not present in a plan view, the underlying layer 41 and the fixed layer 42 are laminated on the structure 2 in this order.

The thickness of a portion of the electrode part 3 which is positioned between the underlying layer 41 and the fixed layer 42 (hereinafter, also referred to simply as “the thickness of the electrode part 3”) is preferably 10 μm or more and more preferably 50 μm or more, in terms of preventing any damage such as a rupture or the like. Further, in terms of suppressing an increase in the size of the joined body 1 in the radial direction at a connection position of the electrode part 3, the thickness of the electrode part 3 is preferably 1000 μm or less and more preferably 500 μm or less. Herein, the thickness of the electrode part 3 refers to a distance between an interface between the electrode part 3 and the underlying layer 41 and that between the electrode part 3 and the fixed layer 42 in the radial direction (i.e., in the up-and-down direction of FIG. 4) at the position of the center C of the fixed layer 42 in a SEM (scanning electron microscope) image magnified 25 times of a polished cross section of the electrode part 3 and the junction part 4.

In terms of increase in the strength of joint of the electrode part 3 to the structure 2, the thickness of the underlying layer 41 is preferably 50 μm or more, and more preferably 100 μm or more. Further, in terms of suppressing an increase in the size of the joined body 1 in the radial direction at the connection position of the electrode part 3, the thickness of the underlying layer 41 is preferably 1000 mm or less, and more preferably 500 mm or less. Herein, the thickness of the underlying layer 41 refers to a distance between the interface between the electrode part 3 and the underlying layer 41 and that between the underlying layer 41 and the electrode layer 25 in the radial direction at the position of the center C of the fixed layer 42 in the above-described SEM image.

In terms of increase in the strength of joint of the electrode part 3 to the structure 2, the thickness of the fixed layer 42 is preferably 100 μm or more, and more preferably 300 μm or more. Further, in terms of suppressing an increase in the size of the joined body 1 in the radial direction at the connection position of the electrode part 3, the thickness of the fixed layer 42 is preferably 10 mm or less, and more preferably 3 mm or less. Herein, the thickness of the fixed layer 42 refers to a distance between the interface between the electrode part 3 and the fixed layer 42 and a surface of the fixed layer 42 outside in the radial direction (i.e., an upper surface in FIG. 4) at the position of the center C of the fixed layer 42 in the above-described SEM image.

The electrode part 3 is formed of, for example, a simple metal or an alloy. In terms of having high corrosion resistance and appropriate electrical resistivity and thermal expansion coefficient, the component of the electrode part 3 is preferably an alloy containing at least one of Cr, Fe, Co, Ni, Ti, and aluminum (Al). The electrode part 3 is preferably stainless steel and more preferably contains Al. Further, the electrode part 3 may be formed of a metal-ceramics mixed member. The metal contained in the metal-ceramics mixed member is, for example, a simple metal such as Cr, Fe, Co, Ni, Si, or Ti or an alloy containing at least one metal selected from a group of these metals. The ceramics contained in the metal-ceramics mixed member is, for example, silicon carbide (SiC) or a metal compound such as metal silicide (e.g., tantalum silicide (TaSi₂) or chromium silicide (CrSi₂)) or the like. As the ceramics, cermet (i.e., a composite material of ceramics and a metal) may be used. The cermet is, for example, a composite material of metallic silicon and silicon carbide, a composite material of metal silicide, metallic silicon, and silicon carbide, or a composite material in which one or more kinds of insulating ceramics such as alumina, mullite, zirconia, cordierite, silicon nitride, aluminum nitride, or the like are added to one or more of the above-described metals. The thermal expansion coefficient (linear expansion coefficient) of the electrode part 3 is, for example, 6×10⁻⁶/K to 18×10⁻⁶/K, and preferably 10×10⁻⁶/K to 15×10⁻⁶/K.

Each of the underlying layer 41 and the fixed layer 42 is formed of, for example, a composite material containing a metal and an oxide. The metal is, for example, one or more of stainless steel, a Ni—Fe alloy, and Si. The oxide is one or more of cordierite-based glass, silicon dioxide (SiO₂), aluminum oxide (Al₂O₃), magnesium oxide (MgO), and a composite oxide of these oxides.

The softening temperature of the oxide is preferably lower than the heating temperature (i.e., the sintering temperature) in later-described formation of the underlying layer 41 and the fixed layer 42. In forming the underlying layer 41 and the fixed layer 42, the oxide is thereby softened and the underlying layer 41 and the fixed layer 42 become dense. The respective porosities of the underlying layer 41 and the fixed layer 42 are each not higher than 10%. Preferably, the respective porosities of the underlying layer 41 and the fixed layer 42 are each not higher than 8%, and more preferably, not higher than 5%. The lower limit of the porosity is not particularly restricted but practically not lower than 1%. The porosities can be obtained by performing image processing of the SEM image of the polished cross section of the underlying layer 41 and the fixed layer 42. The above-described softening temperature of the oxide is a value obtained by a measurement method defined in “JIS R 3103-1”. Further, the oxide preferably contains amorphia. The content (inclusion) of amorphia can be checked from an X-ray diffraction pattern of the underlying layer 41 and the fixed layer 42, and also can be checked by local analysis using the TEM (transmission electron microscope).

Each of the underlying layer 41 and the fixed layer 42 may contain a conductive material other than any metal, instead of the above-described metal or additionally to the above-described metal. The conductive material is, for example, one or more of a boride such as zinc boride, tantalum boride, or the like, a nitride such as titanium nitride, zirconium nitride, or the like, and a carbide such as silicon carbide, tungsten carbide, or the like. The respective components of the underlying layer 41 and the fixed layer 42 may be the same as each other or may be different from each other. In terms of preventing a difference in the characteristics such as the thermal expansion coefficient or the like from occurring, it is preferable that the components of the underlying layer 41 and the fixed layer 42 should be the same.

The respective thermal expansion coefficients (linear expansion coefficients) of the underlying layer 41 and the fixed layer 42 are each, for example, 3×10⁻⁶/K to 10×10⁻⁶/K, and preferably 4×10⁻⁶/K to 8×10⁻⁶/K. The respective thermal expansion coefficients of the underlying layer 41 and the fixed layer 42 are each preferably higher than that of the electrode layer 25 (i.e., the thermal expansion coefficient of a portion of the structure 2 on which the underlying layer 41 is fixed) and lower than that of the electrode part 3. In other words, the thermal expansion coefficient of the underlying layer 41 sandwiched between the electrode layer 25 and the electrode part 3 in the radial direction is a value between the thermal expansion coefficient of the electrode layer 25 and that of the electrode part 3.

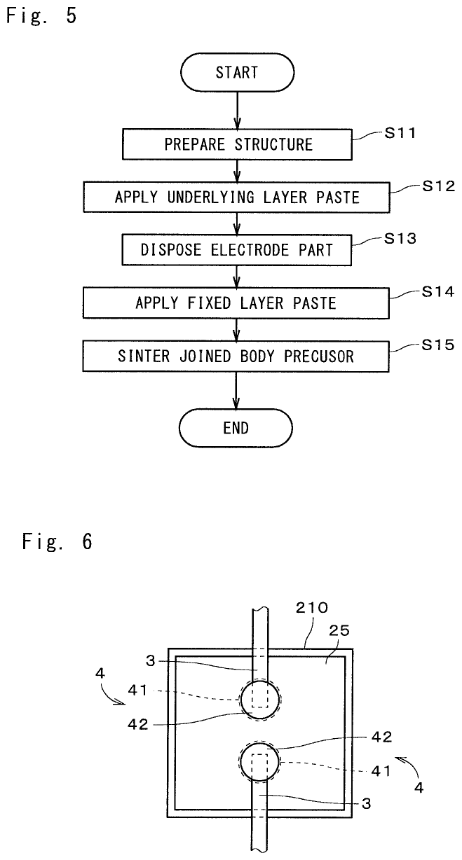

Next, with reference to FIG. 5, an exemplary flow of manufacturing the joined body 1 will be described. First, the structure 2 is formed and prepared (Step S11). In Step S11, a base material green body which is a precursor of the structure 2 is formed and dried. Then, paste-like electrode layer paste which is a raw material of the electrode layer 25 is applied onto an outer surface of the base material green body. After that, the base material green body on which the electrode layer paste is applied is sintered in accordance with a predetermined sintering profile, to thereby form the electrode layer 25 including the base material 20 and the electrode layer 25.

The above-described base material green body is formed, for example, by a method in which a green body raw material is formed by adding a binder, a surfactant, a pore-forming material, water, and the like to raw material powder of the base material 20 and body paste obtained by kneading the green body raw material is extrusion-molded. The above-described electrode layer paste is formed, for example, by adding various additives to raw material powder of the electrode layer 25 and kneading the raw material powder with the additives. Further, in Step S11, there may be a method where before applying the electrode layer paste, the base material green body is sintered, to thereby form the base material 20, and after applying the electrode layer paste onto the base material 20, the base material 20 is sintered again, to thereby form the structure 2.

Subsequently, on the surface of the electrode layer 25 of the structure 2, applied is a paste-like material (hereinafter, also referred to as “underlying layer paste”) which is a raw material of the underlying layer 41 (Step S12). The underlying layer paste is formed, for example, by adding various additives to raw material powder of the underlying layer 41 and kneading the raw material powder with the additives. Further, application of the underlying layer paste onto the electrode layer 25 is performed, for example, by screen printing, coater coating, or the like.

After the application of the underlying layer paste is finished, the electrode part 3 is disposed on the underlying layer paste (Step S13). The electrode part 3 is pushed into the underlying layer paste and a surface of the electrode part 3 (i.e., an upper surface in FIG. 4) is positioned at substantially the same position as that of a surface of the underlying layer paste in the radial direction (i.e., in the up-and-down direction of FIG. 4). Further, a main surface of the electrode part 3 which is in contact with the underlying layer paste (i.e., a lower surface in FIG. 4) is not in direct contact with the electrode layer 25 but is in indirect contact with the electrode layer 25 with the underlying layer paste interposed therebetween.

Next, on the surfaces of the underlying layer paste and the electrode part 3, applied is a paste-like material (hereinafter, also referred to as “fixed layer paste”) which is a raw material of the fixed layer 42. In other words, the fixed layer paste is applied onto the underlying layer paste with the electrode part 3 interposed therebetween. A joined body precursor which is a precursor of the joined body 1 is thereby formed (Step S14). In Step S14, a portion of the electrode part 3 which is positioned on the underlying layer paste is substantially entirely covered with the fixed layer paste. Further, a region of the surface of the underlying layer paste, which is not covered with the electrode part 3, is substantially entirely covered with the fixed layer paste. The fixed layer paste is formed, for example, by adding various additives to raw material powder of the fixed layer 42 and kneading the raw material powder with the additives. Furthermore, application of the fixed layer paste onto the underlying layer paste and the electrode part 3 is performed, for example, by screen printing, coater coating, or the like.

When Step S14 is finished, after the underlying layer paste and the fixed layer paste are dried, the joined body precursor is sintered (Step S15). In other words, the underlying layer paste, the electrode part 3, and the fixed layer paste which are disposed on the structure 2 are sintered together with the structure 2. The junction part 4 which includes the underlying layer 41 and the fixed layer 42 is thereby formed of the underlying layer paste and the fixed layer paste, and the electrode part 3 is fixed on the structure 2 by using the junction part 4, to thereby form the joined body 1. The joined body 1 can be used as the electrically heated catalyst, by causing an inner surface of the cell 23 (i.e., a side surface of the barrier rib 22) to support the catalyst.

Sintering in Step S15 is performed, for example, in an inert atmosphere such as a vacuum atmosphere, a nitrogen atmosphere, or the like. The sintering temperature in Step S15 (i.e., the maximum temperature in sintering) is, for example, not lower than 900° C. and not higher than 1400° C., and preferably not lower than 1000° C. and not higher than 1300° C. The sintering time in Step S15 ranges, for example, from 15 minutes to 2 hours.

As described above, the raw materials of the underlying layer 41 and the fixed layer 42 contain an oxide (e.g., cordierite-based glass) whose softening temperature is lower than the sintering temperature in Step S15. For this reason, while the sintering is performed in Step S15, the softened oxide fills among the particles of the metal or the like, and the underlying layer 41 and the fixed layer 42 which are dense are thereby formed. The respective porosities of the underlying layer 41 and the fixed layer 42 after Step S15 is ended are each not higher than 10%, preferably not higher than 8%, and more preferably not higher than 5%. It is thereby possible to increase the oxidation resistance of the underlying layer 41 and the fixed layer 42 (i.e., the oxidation resistance of the junction part 4), and also possible to increase the joint reliability between the structure 2 and the electrode part 3 even in the high temperature oxidation atmosphere among the exhaust gas of the automobile, or the like.

In the manufacture of the joined body 1, the sintering atmosphere, the sintering temperature, and the sintering time in Step S15 may be changed in various manners. The sintering temperature is, however, set to be higher than the softening temperature of the above-described oxide contained in the underlying layer 41 and the fixed layer 42. Further, the sintering temperature is set to be lower than the melting point of the above-described metal contained in the underlying layer 41 and the fixed layer 42 and the melting point of the material forming the electrode part 3.

In the manufacture of the joined body 1, between Steps S14 and S15, fine powder of coating material such as glass or the like may be sprayed to the underlying layer paste and the fixed layer paste. In this case, since a surface of the junction part 4 is covered with the coating layer such as glass or the like by sintering in Step S15, it is possible to further increase the oxidation resistance of the junction part 4.

Further, in the manufacture of the joined body 1, between Steps S13 and S14, the underlying layer paste and the electrode part 3 disposed on the structure 2 may be once sintered together with the structure 2. The underlying layer 41 is thereby formed on the structure 2 and the electrode part 3 is temporarily fixed on the structure 2 by using the underlying layer 41. After that, in Step S14, the fixed layer paste is applied onto the underlying layer 41 formed by sintering the underlying layer paste and the electrode part 3 which is temporarily fixed on the underlying layer 41. This manufacturing method is useful, for example, for a case where the component of the underlying layer 41 and that of the fixed layer 42 are different from each other and the preferable sintering condition of the underlying layer 41 and that of the fixed layer 42 are different from each other, or the like case.

In the manufacture of the joined body 1, instead of preparation of the structure 2 in Step S11, a structure precursor which is the structure 2 before being sintered may be prepared. In this case, Steps S12 to S14 (specifically, steps of applying the underlying layer paste, disposing the electrode part 3, and applying the fixed layer paste) are executed on the structure precursor. Then, in Step S15, the underlying layer paste, the electrode part 3, and the fixed layer paste are sintered together with the structure precursor, and steps of forming the structure 2 and the junction part 4 and fixing the electrode part 3 on the structure 2 are thereby performed concurrently.

Next, with reference to Tables 1 and 2, Examples of the above-described joined body 1 and joined bodies of Comparative Examples for comparison with the joined body 1 will be described. In Tables 1 and 2, measured values and evaluations are those obtained by using specimens produced correspondingly to Examples and Comparative Examples, respectively. Each of these specimens is obtained, as shown in FIG. 6, by fixing the electrode layer 25 onto a plate-like member 210 which corresponds to part of the cylindrical outer wall 21 of the base material 20 and fixing the two electrode parts 3 onto the electrode layer 25 by using the two junction parts 4 disposed on the electrode layer 25 separately from each other. The interval between the two fixed layers 42 (i.e., the distance between the centers C (see FIG. 3)) is 8 mm. The shapes of each fixed layer 42 and each underlying layer 41 in a plan view is a circle having a diameter of 5 mm.

TABLE 1

| | Composition of | Composition of | | Thickness of | Width of | Thickness of | |
|---|---|---|---|---|---|---|---|
| | Fixed Layer | Underlying Layer | | Fixed Layer | Electrode Part | Electrode Part | Position of |
| | Metal/Oxide | Metal/Oxide | Oxide | (μm) | (mm) | (μm) | Electrode Part |
| Example 1 | 35/65 | 35/65 | Cordierite- | 800 | 2 | 100 | Center |
| | | | based Glass | | | | |
| Example 2 | 35/65 | 35/65 | Cordierite- | 300 | 2 | 100 | Foreground |
| | | | based Glass | | | | |
| Example 3 | 35/65 | 35/65 | Cordierite- | 800 | 2 | 100 | Foreground |
| | | | based Glass | | | | |
| Example 4 | 35/65 | 35/65 | Cordierite- | 100 | 2 | 100 | Center |
| | | | based Glass | | | | |
| Example 5 | 35/65 | 35/65 | Cordierite- | 200 | 3 | 100 | Center |
| | | | based Glass | | | | |
| Example 6 | 35/65 | 35/65 | Cordierite- | 200 | 0.5 | 100 | Through |
| | | | based Glass | | | | |
| Example 7 | 35/65 | 35/65 | Cordierite- | 200 | 2 | 200 | Center |
| | | | based Glass | | | | |
| Example 8 | 40/60 | 40/60 | Cordierite- | 300 | 2 | 100 | Center |
| | | | based Glass | | | | |
| Comparative | — | 35/65 | Cordierite- | — | 2 | 100 | Center |
| Example 1 | | | based Glass | | | | |
| Comparative | 80/20 | 80/20 | Cordierite- | 300 | 2 | 100 | Center |
| Example 2 | | | based Glass | | | | |
| Comparative | 60/40 | 60/40 | Cordierite- | 300 | 2 | 100 | Center |
| Example 3 | | | based Glass | | | | |
| Comparative | 80/20 | 35/65 | Cordierite- | 300 | 2 | 100 | Center |
| Example 4 | | | based Glass | | | | |
| Comparative | 35/65 | 80/20 | Cordierite- | 300 | 2 | 100 | Center |
| Example 5 | | | based Glass | | | | |
| Comparative | 95/5 | 95/5 | Cordierite- | 300 | 2 | 100 | Center |
| Example 6 | | | based Glass | | | | |
| Comparative | 60/40 | 60/40 | Cordierite- | 300 | 2 | 400 | Center |
| Example 7 | | | based Glass | | | | |

TABLE 2

| | | Porosity of | Before | | After 20 Cycles of | | After 50 Cycles of | |
|---|---|---|---|---|---|---|---|---|
| | Porosity of | Underlying | Rising and Falling | | Rising and Falling | | Rising and Falling | |
| | Fixed Layer | Layer | Temperature Test | | Temperature Test | | Temperature Test | |
| | (%) | (%) | Resistance | Strength | Resistance | Strength | Resistance | Strength |
| Example 1 | 3 | 3 | ∘ | ∘ | ∘ | ∘ | ∘ | ∘ |
| Example 2 | 2 | 4 | ∘ | ∘ | ∘ | ∘ | ∘ | Δ |
| Example 3 | 3 | 3 | ∘ | ∘ | ∘ | ∘ | Δ | ∘ |
| Example 4 | 5 | 8 | ∘ | ∘ | ∘ | ∘ | Δ | x |
| Example 5 | 3 | 3 | ∘ | Δ | Δ | Δ | x | x |
| Example 6 | 3 | 1 | ∘ | Δ | ∘ | Δ | ∘ | Δ |
| Example 7 | 2 | 2 | ∘ | Δ | Δ | Δ | x | x |
| Example 8 | 7 | 5 | ∘ | ∘ | ∘ | ∘ | ∘ | Δ |
| Comparative | — | 1 | x | x | x | x | x | x |
| Example 1 | | | | | | | | |
| Comparative | 19 | 17 | ∘ | ∘ | x | x | x | x |
| Example 2 | | | | | | | | |
| Comparative | 11 | 12 | ∘ | ∘ | x | x | x | x |
| Example 3 | | | | | | | | |
| Comparative | 18 | 2 | ∘ | ∘ | x | x | x | x |
| Example 4 | | | | | | | | |
| Comparative | 2 | 18 | ∘ | ∘ | x | x | x | x |
| Example 5 | | | | | | | | |
| Comparative | 22 | 25 | ∘ | ∘ | x | x | x | x |
| Example 6 | | | | | | | | |
| Comparative | 44 | 46 | ∘ | ∘ | x | x | x | x |
| Example 7 | | | | | | | | |

In Table 1, the composition of fixed layer and the composition of underlying layer indicate respective percentages (mass %) of the above-described metal and oxide contained in the fixed layer 42 and the underlying layer 41. In each of Examples and Comparative Examples, the metal is stainless steel. Further, in each of Examples and Comparative Examples 1 to 5, the oxide is cordierite-based glass. On the other hand, in each of Comparative Examples 6 and 7, the oxide is crystalline cordierite. The thickness of fixed layer and the thickness of electrode part indicate the respective thicknesses of the fixed layer 42 and the electrode part 3 at the center C of the fixed layer 42, as described above. The width of electrode part indicates the width of the electrode part 3 at the position overlapping the center C of the fixed layer 42 in a plan view. In other words, the width of electrode part indicates the width of the strip-like electrode part 3 in a direction perpendicular to the longitudinal direction and a thickness direction thereof and corresponds to the width in the left and right direction of FIG. 3. Further, though not described in Table, the thickness of the underlying layer 41 at the center C of the fixed layer 42 is 100 μm to 300 μm.

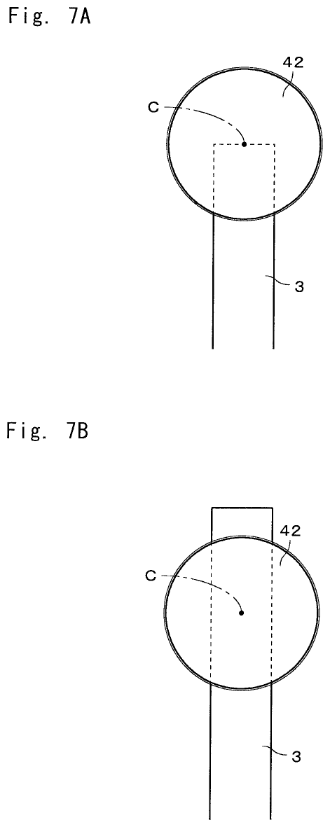

In Table 1, the position of electrode part indicates a positional relation between the center C of the fixed layer 42 and the electrode part 3. In the column of “Position of Electrode Part”, “Center” indicates a state where the tip of the electrode part 3 (i.e., the upper end in FIG. 3) does not protrude from the fixed layer 42 and a portion of the electrode part 3 on the root side from the tip (i.e., a portion lower than the upper end in FIG. 3) overlaps the center C of the fixed layer 42, as shown in FIG. 3. In the column of “Position of Electrode Part”, “Foreground” indicates a state where the tip of the electrode part 3 (i.e., the upper end in FIG. 7A) overlaps the center C of the fixed layer 42, as shown in FIG. 7A. In the column of “Position of Electrode Part”, “Through” indicates a state where the electrode part 3 penetrates the fixed layer 42 in the up-and-down direction of FIG. 7B (i.e., a state where the tip and a portion on the root side of the electrode part 3 protrude from the fixed layer 42), as shown in FIG. 7B.

The electrode part 3 and the electrode layer 25 are joined to each other by sintering in Steps S12 to S15 described above. The sintering atmosphere, the sintering temperature, and the sintering time in Step S15 are assumed to be a vacuum atmosphere, 1100° C., and 30 minutes, respectively.

In Table 2, the porosity of fixed layer and the porosity of underlying layer indicate the respective porosities of the fixed layer 42 and the underlying layer 41 which are obtained from the SEM image as described above. The porosities are obtained by performing image binarization processing using image analysis software on the SEM image (magnified 100 times) of the polished cross section of the fixed layer 42 and the underlying layer 41 and dividing the number of pixels corresponding to pores by the number of all pixels. As the SEM, used is “S-3400N” of Hitachi High-Tech Corporation. As the image analysis software, used is “Image Pro Premier 9” of Media Cybernetics, Inc.

In each of Examples and Comparative Examples, as shown in Table 2, a rising and falling temperature test is performed on each of the above-described specimens, and the resistance of the junction part 4 (hereinafter, also referred to simply as “resistance”) and the strength of the electrode part 3 and the junction part 4 (hereinafter, also referred to simply as “strength”) are evaluated. Specifically, in Table 2, the resistance and the strength before the rising and falling temperature test is performed, the resistance and the strength in the state after 20 cycles of the rising and falling temperature test are performed, and the resistance and the strength in the state after 50 cycles of the rising and falling temperature test are performed are evaluated with “◯”, “Δ”, or “X”. In the rising and falling temperature test, the above-described specimen is put in a rapid rising and falling temperature furnace, and the temperature of the specimen is raised and lowered in a range from 50° C. to 900° C. in an air atmosphere. Specifically, in rising and falling temperature for one cycle, the temperature of the specimen is raised from 50° C. to 900° C. in one minute and lowered from 900° C. to 50° C. in one minute.

The resistance of the junction part 4 is a value obtained by measuring the resistance between two points of the junction part 4 by the two-probe (two-terminal) method using a tester. In Table 2, a case where the resistance of the junction part 4 before the rising and falling temperature test is not higher than 3Ω is evaluated as “◯”, and another case where the resistance is higher than 3Ω is evaluated as “X”. Further, a case where the resistance of the junction part 4 after 20 cycles is not higher than three times the resistance of the junction part 4 before the rising and falling temperature test is evaluated as “◯”, another case where the resistance is higher than three times and not higher than five times is evaluated as “Δ”, and still another case where the resistance is higher than five times is evaluated as “X”. The same applies to the evaluation on the resistance of the junction part 4 after 50 cycles.

As to the strength of the electrode part 3 and the junction part 4, an end portion of the electrode part 3 which protrudes from the junction part 4 is fixed to the digital force gauge (“ZTA-200N” of IMADA Co., Ltd.) and the electrode part 3 is pulled along the longitudinal direction of the electrode part 3, and when there occurs a rupture in the electrode part 3 or a breakage in the fixed layer 42, the tensile strength is measured. In Table 2, in each timing of “before the rising and falling temperature test”, “after 20 cycles”, and “after 50 cycles”, a case where the tensile strength is not lower than 70 N is evaluated as “◯”, another case where the tensile strength is not lower than 40 N and lower than 70 N is evaluated as “Δ”, and still another case where the tensile strength is lower than 40 N is evaluated as “X”.

In Examples 1 to 7, each of the compositions of the fixed layer 42 and the underlying layer 41 is metal: 35 mass % and oxide: 65 mass %. Further, in Example 8, each of the compositions of the fixed layer 42 and the underlying layer 41 is metal: 40 mass % and oxide: 60 mass %. In Examples 1 to 8, the thickness of the fixed layer 42 is changed in a range from 100 μm to 800 μm, the width of the electrode part 3 is changed in a range from 0.5 mm to 3 mm, and the thickness of the electrode part 3 is changed in a range from 100 μm to 200 μm. Furthermore, in Examples 1 to 8, the position of the electrode part 3 is any one of “Center”, “Foreground”, and “Through”.

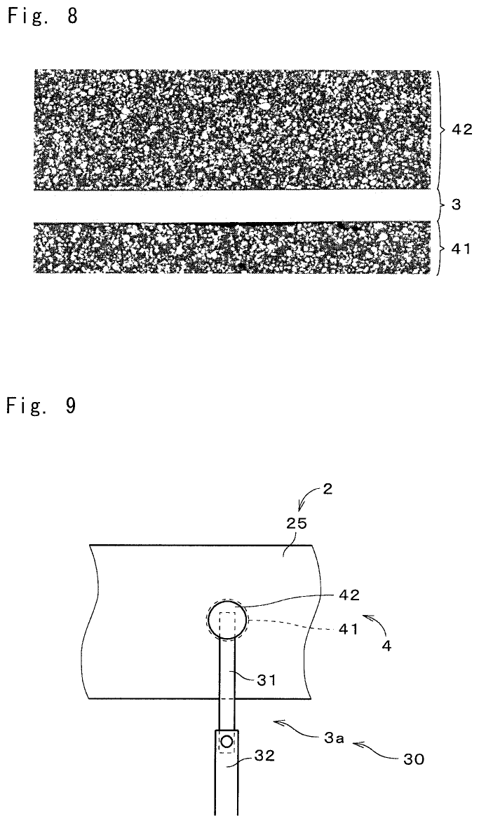

In Examples 1 to 8, the porosity of the fixed layer 42 is low, ranging from 2% to 7% (in other words, not higher than 10%), and the porosity of the underlying layer 41 is also low, ranging from 1% to 8% (in other words, not higher than 10%). FIG. 8 is a SEM image showing a cross section of the fixed layer 42, the electrode part 3, and the underlying layer 41 in Example 1. A white portion in the fixed layer 42 and the underlying layer 41 represents the metal (stainless steel) and a gray portion thereof represents the oxide (cordierite-based glass). As shown in FIG. 8, the metal (white portion) is dispersed in the oxide (gray portion). Further, there is no or almost no black portion representing the pore in the fixed layer 42 and the underlying layer 41.

In Examples 1 to 8, the respective evaluations on the resistance and the strength before the rising and falling temperature test are good as indicated by “◯” or “Δ”, and the respective evaluations on the resistance and the strength after 20 cycles of the rising and falling temperature test are also good as indicated by “◯” or “Δ”. In other words, since the fixed layer 42 and the underlying layer 41 in Examples 1 to 8 each have a low porosity of not higher than 10%, the oxidation resistance is high and the joint reliability (i.e., the mechanical joint reliability and the electrical joint reliability) is maintained even after 20 cycles of the rising and falling temperature test.

On the other hand, in Comparative Example 1, the underlying layer 41 is formed like in Example 1 but the fixed layer 42 is not formed. In Comparative Example 1, the evaluations on the resistance and the strength before the rising and falling temperature test are not good as indicated by “X”.

In Comparative Example 2, each of the compositions of the fixed layer 42 and the underlying layer 41 is metal: 80 mass % and oxide: 20 mass %. The porosities of the fixed layer 42 and the underlying layer 41 are high, 19% and 17% (in other words, higher than 10%), respectively. For this reason, the oxidation resistance of the fixed layer 42 and the underlying layer 41 is low, and the evaluations on the resistance and the strength before the rising and falling temperature test are good as indicated by “◯” but the evaluations on the resistance and the strength after 20 cycles of the rising and falling temperature test are not good as indicated by “X”.

In Comparative Example 3, each of the compositions of the fixed layer 42 and the underlying layer 41 is metal: 60 mass % and oxide: 40 mass %. The porosities of the fixed layer 42 and the underlying layer 41 are high, 11% and 12% (in other words, higher than 10%), respectively. For this reason, the oxidation resistance of the fixed layer 42 and the underlying layer 41 is low, and the evaluations on the resistance and the strength before the rising and falling temperature test are good as indicated by “◯” but the evaluations on the resistance and the strength after 20 cycles of the rising and falling temperature test are not good as indicated by “X”.

In Comparative Example 4, the composition of the fixed layer 42 is metal: 80 mass % and oxide: 20 mass %, like in Comparative Example 2, and the composition of the underlying layer 41 is metal: 35 mass % and oxide: 65 mass %, like in Example 1. The porosity of the underlying layer 41 is low, 2% (in other words, not higher than 10%) but the porosity of the fixed layer 42 is high, 18% (in other words, higher than 10%). For this reason, the oxidation resistance of the fixed layer 42 is low and the evaluations on the resistance and the strength before the rising and falling temperature test are good as indicated by “◯”, but the evaluations on the resistance and the strength after 20 cycles of the rising and falling temperature test are not good as indicated by “X”.

In Comparative Example 5, the composition of the fixed layer 42 is metal: 35 mass % and oxide: 65 mass %, like in Example 1, and the composition of the underlying layer 41 is metal: 80 mass % and oxide: 20 mass %, like in Comparative Example 2. The porosity of the fixed layer 42 is low, 2% (in other words, not higher than 10%) but the porosity of the underlying layer 41 is high, 18% (in other words, higher than 10%). For this reason, the oxidation resistance of the underlying layer 41 is low and the evaluations on the resistance and the strength before the rising and falling temperature test are good as indicated by “◯”, but the evaluations on the resistance and the strength after 20 cycles of the rising and falling temperature test are not good as indicated by “X”.

In Comparative Example 6, as described above, as the oxide contained in the fixed layer 42 and the underlying layer 41, crystalline cordierite is used, instead of cordierite-based glass. Each of the compositions of the fixed layer 42 and the underlying layer 41 is metal: 95 mass % and oxide: 5 mass %. The porosities of the fixed layer 42 and the underlying layer 41 are high, 22% and 25% (in other words, higher than 10%), respectively. For this reason, the oxidation resistance of the fixed layer 42 and the underlying layer 41 is low, and the evaluations on the resistance and the strength before the rising and falling temperature test are good as indicated by “◯” but the evaluations on the resistance and the strength after 20 cycles of the rising and falling temperature test are not good as indicated by “X”.

In Comparative Example 7, like in Comparative Example 6, the oxide contained in the fixed layer 42 and the underlying layer 41 is crystalline cordierite. Each of the compositions of the fixed layer 42 and the underlying layer 41 is metal: 60 mass % and oxide: 40 mass %, like in Comparative Example 3. The porosities of the fixed layer 42 and the underlying layer 41 are high, 44% and 46% (in other words, higher than 10%), respectively. For this reason, the oxidation resistance of the fixed layer 42 and the underlying layer 41 is low, and the evaluations on the resistance and the strength before the rising and falling temperature test are good as indicated by “◯” but the evaluations on the resistance and the strength after 20 cycles of the rising and falling temperature test are not good as indicated by “X”.

In comparison between Example 1 (the position of electrode part: Center) and Example 3 (the position of electrode part: Foreground) in Tables 1 and 2, in Example 1 where the overlapped area of the electrode part 3 and the fixed layer 42 is large, the evaluation on the resistance after 50 cycles of the rising and falling temperature test is “◯”, and in Example 3 where the overlapped area is small, the evaluation is “Δ”. From this point, it can be thought that it is preferable that the overlapped area should be large to some degree. Further, though not described in Tables, in terms of suppressing an increase in the resistance and reduction in the strength after the rising and falling temperature test, the area of a portion of the electrode part 3 which overlaps the fixed layer 42 in a plan view is preferably not smaller than 5% and not larger than 80% of the area of the fixed layer 42 in a plan view and more preferably not smaller than 25% and not larger than 50%, as described above. The case of 5% corresponds to the state where the electrode part 3 having a width of 0.5 mm is disposed “Foreground” as the position of electrode part, and the case of 80% corresponds to the state where the electrode part 3 having a width of 0.5 mm is disposed “Through” as the position of electrode part.

In comparison between Example 1 (the thickness of fixed layer: 800 μm) and Example 4 (the thickness of fixed layer: 100 μm), the evaluations on the resistance and strength after 20 cycles of the rising and falling temperature test are “◯” and “◯”, respectively, in both Examples 1 and 4. Further, the evaluations on the resistance and strength after 50 cycles of the rising and falling temperature test are “◯” and “◯”, respectively, in Example 1 where the fixed layer 42 is thick, and the evaluations are “Δ” and “X”, respectively, in Example 4 where the fixed layer 42 is thin. From this point, it can be thought that the thickness of the fixed layer 42 is preferably not smaller than 100 μm and further preferably larger than 100 μm.

Paying attention to Example 4 (the thickness of fixed layer and the thickness of electrode part: 100 μm) and Example 7 (the thickness of fixed layer and the thickness of electrode part: 200 μm), the evaluations on the resistance and strength before the rising and falling temperature test and after 20 cycles of the rising and falling temperature test are “◯” and “Δ”, respectively, but the evaluations on the resistance and strength after 50 cycles of the rising and falling temperature test are “Δ” and “X”, respectively. From this point, it can be thought that the thickness of the fixed layer 42 and that of the electrode part 3 may be the same but it is more preferable that the fixed layer 42 should be thicker than the electrode part 3 (e.g., in Example 1).

As described above, the joined body 1 includes the junction target (the structure 2 in the above-described exemplary case), the underlying layer 41, the electrode part 3, and the fixed layer 42. The conductive underlying layer 41 is fixed on the surface of the junction target. The electrode part 3 is fixed on the underlying layer 41. The conductive fixed layer 42 is fixed on the underlying layer 41 with the electrode part 3 interposed therebetween. The respective porosities of the underlying layer 41 and the fixed layer 42 are each not higher than 10%. It is thereby possible to achieve high oxidation resistance in the junction between the junction target and the electrode part 3, as shown in Examples 1 to 8. As a result, the joint reliability of the electrode part 3 (i.e., the mechanical joint reliability and the electrical joint reliability) can be increased.

Preferably, the above-described junction target is a conductive carrier for supporting a catalyst in the electrically heated catalyst (EHC), and the electrode part 3 is part of the electrode terminal 30 supplying electric power to the carrier. Since the joined body 1 can achieve high oxidation resistance in the junction between the junction target and the electrode part 3, as described above, the joined body 1 is especially suitable for the use in the electrically heated catalyst to be used in the high temperature oxidation atmosphere inside the exhaust pipe of the automobile or the like.

Preferably, the above-described junction target includes the conductive base material 20 having a honeycomb structure and the conductive electrode layer 25 disposed between the underlying layer 41 and the outer surface of the base material 20. Since the current supplied to the junction target through the electrode part 3 is thereby spread by the electrode layer 25, the uniformity of the current flowing in the base material 20 can be increased. As a result, the uniformity of heat generation of the base material 20 can be increased.

As described above, it is preferable that the underlying layer 41 and the fixed layer 42 should each contain a metal and an oxide. It is thereby possible to suitably form the underlying layer 41 and the fixed layer 42 which are dense, each having a porosity not higher than 10%. More preferably, the softening temperature of the oxide is lower than the heating temperature in formation of the underlying layer 41 and the fixed layer 42. Since the softened oxide thereby fills among the particles of the above-described metal in formation of the underlying layer 41 and the fixed layer 42, it is possible to more suitably form the underlying layer 41 and the fixed layer 42 which are dense. Further, the oxide preferably contains amorphia. Since the oxide thereby more easily fills among the particles of the above-described metal, it is possible to more suitably form the underlying layer 41 and the fixed layer 42 which are dense.

As described above, it is preferable that the component of the underlying layer 41 and that of the fixed layer 42 should be the same as each other. It is thereby possible to prevent a thermal stress from being generated due to a difference in the thermal expansion coefficient between the underlying layer 41 and the fixed layer 42 and further possible to prevent deformation and damage of the junction part 4 due to the thermal stress. Further, since the sintering condition and the like of the underlying layer 41 and those of the fixed layer 42 are the same, it is possible to simplify formation of the junction part 4 and manufacture of the joined body 1.

As described above, it is preferable that the thickness of the fixed layer 42 should be not smaller than 100 μm. It is thereby possible to increase the joint strength of the electrode part 3 to the structure 2. As a result, the joint reliability of the electrode part 3 can be increased.

As described above, it is preferable that the area of a portion of the electrode part 3 which overlaps the fixed layer 42 in a plan view should be not smaller than 5% of the area of the fixed layer 42 in a plan view and not larger than 80% thereof. It is thereby possible to increase the joint strength of the electrode part 3 to the structure 2. As a result, the joint reliability of the electrode part 3 can be increased.

As described above, it is preferable that the thickness of a portion of the electrode part 3 which is positioned between the underlying layer 41 and the fixed layer 42 should be not smaller than 10 μm and not larger than 1000 μm. It is thereby possible to increase the joint strength of the electrode part 3 to the structure 2. As a result, the joint reliability of the electrode part 3 can be increased.

As described above, it is preferable that the electrode part 3 should contain aluminum (Al). It is thereby possible to achieve high oxidation resistance in the electrode part 3. As a result, the joint reliability of the electrode part 3 can be increased.

As described above, it is preferable that the respective thermal expansion coefficients of the underlying layer 41 and the fixed layer 42 should be larger than the thermal expansion coefficient of a portion (the electrode layer 25 in the above-described exemplary case) of the junction target on which the underlying layer 41 is fixed and should be smaller than that of the electrode part 3. The underlying layer 41 can thereby serve as a stress relaxation layer for relaxing the thermal stress due to a difference in the thermal expansion coefficient between the electrode layer 25 and the electrode part 3. As a result, it is possible to suppress a damage (e.g., a crack of the electrode layer 25 or the like) of the junction target from occurring in joining the electrode part 3 or repeating the heat cycle in the use of the joined body 1. Further, since the underlying layer 41 and the fixed layer 42 are dense as described above, the Young's modulus tends to be higher as compared with a case where these layers are porous, but it is possible to suppress occurrence of the above-described thermal stress and therefore possible to prevent the underlying layer 41 and the fixed layer 42 from being damaged due to the thermal stress.

As described above, the underlying layer 41 and the fixed layer 42 are preferably formed by sintering the raw material disposed on the junction target (the structure 2 in the above-described exemplary case) together with the junction target. It is thereby possible to easily manufacture the joined body 1 including the underlying layer 41 and the fixed layer 42 which are dense.

The method of manufacturing the above-described joined body 1 includes the step of applying the underlying layer paste which is a raw material of the underlying layer 41 onto the surface of the junction target (Step S12), the step of disposing the electrode part 3 on the underlying layer paste (Step S13), the step of forming the joined body precursor by applying the fixed layer paste which is a raw material of the fixed layer 42 onto the underlying layer paste or the underlying layer 41 formed by sintering the underlying layer paste, with the electrode part 3 interposed therebetween (Step S14), and the step of sintering the joined body precursor (Step S15). In Step S15, the sintering temperature is not lower than 900° C. and not higher than 1400° C., and the sintering atmosphere is an inert gas atmosphere. The respective porosities of the underlying layer 41 and the fixed layer 42 after Step S15 is ended are each not higher than 10%. According to the manufacturing method, it is possible to achieve high oxidation resistance in the junction between the junction target and the electrode part 3.

In the joined body 1, the structure of the electrode part 3 is not limited to the structure shown in FIG. 2 but may be modified in various manners. FIG. 9 is a plan view showing the vicinity of an electrode part 3a having a structure different from that of the electrode part 3 shown in FIG. 2. The electrode part 3a includes a conductive first portion 31 and a conductive second portion 32. The first portion 31 is, for example, a substantially strip-like metal foil. The second portion 32 is, for example, a substantially strip-like sheet metal and part of the above-described electrode terminal 30. The respective components of the first portion 31 and the second portion 32 are, for example, the same as that of the above-described electrode part 3.

The first portion 31 is extended out from between the underlying layer 41 and the fixed layer 42 of the junction part 4. In the exemplary case shown in FIG. 9, the first portion 31 protrudes downward from the lower end portion of the junction part 4 in FIG. 9, being astride a lower end edge of the electrode layer 25, and is extended out to the outside of the electrode layer 25. In FIG. 9, the second portion 32 is joined to the first portion 31 by welding on the lower side from the lower end edge of the electrode layer 25. In the exemplary case shown in FIG. 9, an upper end portion of the second portion 32 is superimposed on a lower end portion of the first portion 31, and the second portion 32 is joined to the first portion 31 by welding. In FIG. 9, a weld mark on the second portion 32 is represented by a circle. The first portion 31 and the second portion 32 are welded to each other at a position away from the junction part 4. Further, a welded portion between the first portion 31 and the second portion 32 is positioned at a position also away from the electrode layer 25.

Welding of the first portion 31 and the second portion 32 is performed after joining the first portion 31 on the structure 2 by using the junction part 4. Joining of the first portion 31 to the structure 2 is performed by using the first portion 31 of the electrode part 3a, instead of the electrode part 3, in the manufacturing method of the joined body 1, consisting of Steps S11 to S15. In other words, the second portion 32 is joined to the first portion 31 after the first portion 31 is joined onto the structure 2 by sintering in Step S15.

As described above, the electrode part 3a shown in FIG. 9 includes the first portion 31 extended out from between the underlying layer 41 and the fixed layer 42 and the second portion 32 joined to the first portion 31 by welding at the position away from the underlying layer 41 and the fixed layer 42. In joining the electrode part 3a and the structure 2 by sintering, only the first portion 31 of the electrode part 3a is thereby put into a sintering furnace together with the structure 2, without putting the electrode terminal 30 including the second portion 32 into the sintering furnace. Therefore, the precursor of the joined body 1 to be put into the sintering furnace can be downsized. As a result, it is possible to simplify the manufacture of the joined body 1.

In the joined body 1 and the method of manufacturing the joined body 1 which are described above, various modifications can be made.

For example, the thickness of the portion of the electrode part 3, which is positioned between the underlying layer 41 and the fixed layer 42, may be smaller than 10 μm or may be larger than 1000 μm.

The component of the electrode part 3 may be changed as appropriate and does not necessarily need to contain Al. The same applies to the electrode part 3a.

The area of the portion of the electrode part 3, which overlaps the fixed layer 42 in a plan view, may be smaller than 5% or may be larger than 80% of the area of the fixed layer 42 in a plan view.

The respective shapes, sizes, and thicknesses of the underlying layer 41 and the fixed layer 42 in a plan view may be changed in various manners. For example, the thickness of the fixed layer 42 may be smaller than 100 μm.

In the case where the underlying layer 41 contains a metal and an oxide, the softening temperature of the oxide does not necessarily need to be lower than the heating temperature in the formation of the underlying layer 41 (the sintering temperature in Step S15 in the above-described exemplary case) but may be not lower than the heating temperature. The same applies to the fixed layer 42. Further, the underlying layer 41 and the fixed layer 42 do not necessarily need to contain a metal and an oxide.

The respective thermal expansion coefficients of the underlying layer 41 and the fixed layer 42 may be each lower than that of the portion of the above-described junction target (the electrode layer 25 of the structure 2 in the above-described exemplary case), on which the underlying layer 41 is fixed, and may be not lower than that of the electrode part 3.

The structure of the above-described junction target may be changed in various manners. There may be a structure, for example, where the electrode layer 25 is omitted from the structure 2 which is the junction target and the underlying layer 41 of the junction part 4 is directly fixed on the surface of the base material 20 having a honeycomb structure.

The joined body 1 may be used for any use (e.g., a ceramic heater) other than the electrically heated catalyst. Further, in the joined body 1, the structure of the base material 20 is not limited to the honeycomb structure but may be changed to any one of various structures, such as a substantially cylindrical shape, a substantially flat plate-like shape, or the like. Furthermore, the base material 20 may be formed of any component other than ceramics.

Only if the underlying layer 41 and the fixed layer 42 each have a porosity not higher than 10%, these layers do not necessarily need to be formed by sintering the raw materials together with the junction target but may be formed by any other method. Similarly, the method of manufacturing the joined body 1 is not limited to the method consisting of Steps S1 to S15 described above.

The configurations in the above-discussed preferred embodiment and variations may be combined as appropriate only if those do not conflict with one another.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The present invention can be used for the electrically heated catalyst or the like which is used for the purification treatment of exhaust gas from an engine of an automobile or the like.

### REFERENCE SIGNS LIST

1 Joined body
3, 3a Electrode part
20 Base material
25 Electrode layer
31 First portion
32 Second portion
41 Underlying layer
42 Fixed layer
S11 to S15 Step

1. A joined body, comprising:
a junction target;
a conductive underlying layer fixed on a surface of said junction target;
an electrode part fixed on said conductive underlying layer; and
a conductive fixed layer fixed on said conductive underlying layer with said electrode part interposed therebetween,
wherein respective porosities of said conductive underlying layer and said conductive fixed layer are each not higher than 10%.

2. The joined body according to claim 1, wherein
said junction target is a conductive carrier for supporting a catalyst in an electrically heated catalyst, and
said electrode part is part of an electrode terminal for supplying electric power to said conductive carrier.

3. The joined body according to claim 1, wherein
said junction target includes
a conductive base material having a honeycomb structure; and
a conductive electrode layer disposed between said conductive underlying layer and an outer surface of said conductive base material.

4. The joined body according to claim 1, wherein
each of said conductive underlying layer and said conductive fixed layer contains a metal and an oxide.

5. The joined body according to claim 4, wherein
the softening temperature of said oxide is lower than the heating temperature in formation of said conductive underlying layer and said conductive fixed layer.

6. The joined body according to claim 1, wherein
the component of said conductive underlying layer is the same as that of said conductive fixed layer.

7. The joined body according to claim 1, wherein
the thickness of said conductive fixed layer is not smaller than 100 μm.

8. The joined body according to claim 1, wherein
the area of a portion of said electrode part, which overlaps said conductive fixed layer in a plan view, is not smaller than 5% and not larger than 80% of the area of said conductive fixed layer in a plan view.

9. The joined body according to claim 1, wherein
the thickness of a portion of said electrode part, which is positioned between said conductive underlying layer and said conductive fixed layer, is not smaller than 10 μm and not larger than 1000 μm.

10. The joined body according to claim 1, wherein
said electrode part contains aluminum.

11. The joined body according to claim 1, wherein
respective thermal expansion coefficients of said conductive underlying layer and said conductive fixed layer are each higher than that of a portion of said junction target, on which said conductive underlying layer is fixed, and lower than that of said electrode part.

12. The joined body according to claim 1, wherein
said conductive underlying layer and said conductive fixed layer are formed by sintering a raw material disposed on said junction target, together with said junction target.

13. The joined body according to claim 1, wherein
said electrode part includes
a first portion extended out from between said conductive underlying layer and said conductive fixed layer; and
a second portion joined to said first portion by welding at a position away from said conductive underlying layer and said conductive fixed layer.

14. A method of manufacturing a joined body which includes a junction target, a conductive underlying layer fixed on a surface of said junction target, an electrode part fixed on said conductive underlying layer, and a conductive fixed layer fixed on said conductive underlying layer with said electrode part interposed therebetween, comprising:
a) applying underlying layer paste which is a raw material of said conductive underlying layer, onto a surface of said junction target;
b) disposing said electrode part on said underlying layer paste;
c) forming a joined body precursor by applying fixed layer paste which is a raw material of said conductive fixed layer, onto said underlying layer paste or said conductive underlying layer which is formed by sintering said underlying layer paste, with said electrode part interposed therebetween; and
d) sintering said joined body precursor,
wherein the sintering temperature is not lower than 900° C. and not higher than 1400° C. and the sintering atmosphere is an inert gas atmosphere in said operation d), and
respective porosities of said conductive underlying layer and said conductive fixed layer after said operation d) are each not higher than 10%.
